(19) United States
(12) Patent Application Publication
(10) Pub. No.: US 2014/0070783 A1
(43) Pub. Date: Mar. 13, 2014

(54) CONSTANT VOLTAGE SUPPLY CONSTRUCTED USING A CONSTANT CURRENT BOOST CONTROLLER

(71) Applicant: MICREL, INC., San Jose, CA (US)

(72) Inventor: Vincent Stueve, Round Rock, TX (US)

(73) Assignee: Micrel, Inc., San Jose, CA (US)

(21) Appl. No.: 13/852,962

(22) Filed: Mar. 28, 2013

Related U.S. Application Data
(60) Provisional application No. 61/698,571, filed on Sep. 8, 2012.

(51) Int. Cl. H02M 3/156

(52) U.S. Cl. CPC H02M 3/156
USPC 323/282

(57) ABSTRACT

A constant voltage supply uses a constant current boost switching controller to generate an output voltage having a substantially constant voltage magnitude. The constant voltage supply thus constructed realizes fast transient response with small output capacitance.

### CROSS REFERENCE TO OTHER APPLICATIONS

This application claims priority to U.S. Provisional Patent Application No. 61/698,571 entitled CONSTANT VOLTAGE SUPPLY CONSTRUCTED USING A CONSTANT CURRENT BOOST CONTROLLER, filed Sep. 8, 2012 which is incorporated herein by reference for all purposes.

### BACKGROUND OF THE INVENTION

Marine depth finders or fish finders are instruments used to locate the bottom of a body of water or to locate fish underwater by detecting reflected pulses of sound energy, as in SONAR. In operation, a marine depth/fish finder includes a transmitter which applies an electrical impulse to an underwater transducer, also referred to as “pinging” the transducer. The transducer converts the electrical impulse into a high frequency sound wave which is sent into the water. When the sound wave strikes an object, such as a fish or the bottom of the body of water, the wave is reflected back to the transducer as an echo. When the returning echo strikes the transducer, the transducer converts the sound back into electrical energy which is sent to the depth/fish finder's receiver. Analysis of the return echo provides information on the size, composition, and shape of the object. The exact extent of what can be discerned from the return echo depends on the frequency and power of the pulse transmitted.

Transducers such as piezoelectric elements or transformer-based elements require a high voltage to “ping” with. A high voltage is often required to “ping” the transformer or transducer in order to attain a large enough signal out that can then be read on the return echo. Traditional methods in depth/fish finders to “ping” the transducer use complicated circuitry and big capacitors to generate the required high voltage and store the energy necessary to “ping” the transducer.

### BRIEF DESCRIPTION OF THE DRAWINGS

Various embodiments of the invention are disclosed in the following detailed description and the accompanying drawings.

FIG. 1 is a schematic diagram of a constant output current converter configured to drive one or more strings of high power light emitting diodes (LEDs).

FIG. 2 is a schematic diagram of a constant voltage supply constructed using a constant current boost switching controller according to one embodiment of the present invention.

### DETAILED DESCRIPTION

The invention can be implemented in numerous ways, including as a process; an apparatus; a system; and/or a composition of matter. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In embodiments of the present invention, a constant voltage supply is constructed using a constant current boost switching controller. The constant voltage supply thus constructed realizes fast transient response with small output capacitance. Furthermore, the constant voltage supply may be configured to generate a high output voltage using off-the-shelf inductor components and does not require custom transformer. The constant voltage supply of the present invention can be implemented with reduced cost and reduced system footprint.

In some applications, such as marine depth finders and fish finders, it is necessary to generate a high constant voltage and apply brief pulses (“pings”) of current into a transducer load. These “pings” pull large amounts of current for very short amounts of time. In conventional solutions, a large value capacitor or complex circuits are used to hold the charge during the “ping”. Such conventional solutions are often expensive and bulky.

In embodiments of the present invention, a constant voltage supply is constructed from a constant current boost switching controller to generate a high output voltage and deliver pulses of current while using a small value output capacitor. The constant voltage supply can thus generate a high output voltage with fast transient response for reduced drop in the ping voltage. The constant voltage supply has particular applications in driving transducers where the high constant voltage is used to generate pulses of current to ping the transducer.

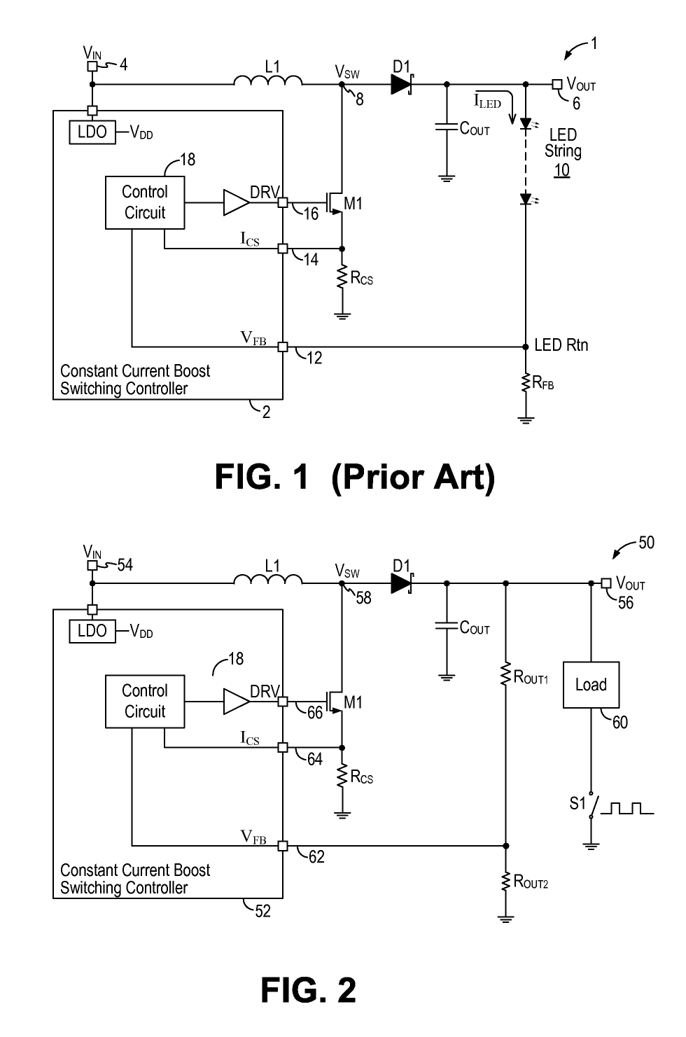

FIG. 1 is a schematic diagram of a constant output current converter configured to drive one or more strings of high power light emitting diodes (LEDs). A constant output current converter is the preferred method for driving LEDs. Referring to FIG. 1, the constant output current converter 1 receives an input voltage V_{IN} (node 4) and generates an output voltage V_{OUT} (node 6) that is greater than the input voltage. The constant output current converter 1 includes a constant current boost switching controller 2 driving a switch M1. The converter 1 further includes an inductor L1 and a diode D1 connected in series between the input voltage V_{IN} and the output voltage V_{OUT}. The node 8 between the inductor L1 and the diode D1 is connected to the drain of the switch M1 and is the switching voltage V_{SW}. An output capacitor C_{OUT} is connected between the output voltage V_{OUT} (node 6) and ground. The operation of the boost converter is well known and will not be further described.

The constant current boost switching controller 2 receives feedback signals to control the switching of the switch M1 to regulate the output current I_{LED} to a constant level. A current sense resistor R_{CS} connected between the source (node 14) of switch M1 and ground is used to sense the current I_{CS} flowing through the switch. A feedback resistor R_{FB} connected between the LED string 10 (at the LED return node 12) and ground is used to sense the current flowing in the LED string. The voltage drop across the resistor R_{FB} generates a feedback voltage V_{FB} (node 12). The switch current I_{CS} and the LED current feedback voltage V_{FB} are coupled to a control circuit 18 in the controller to generate the drive signal DRV (node 16) for driving the switch M1. The switch M1 is turned on and off to maintain a constant level of LED current I_{LED}. As thus configured, the constant current converter receives an input voltage and generates a constant current output I_{LED} for powering the LED string. The resistance of the feedback resistor R_{FB} is selected to set the desired LED current value.

FIG. 1 illustrates the use of a constant current boost switching controller to construct a constant output current converter to generate a constant output current. In embodiments of the present invention, the same constant current boost switching controller is used to construct a constant voltage supply.

FIG. 2 is a schematic diagram of a constant voltage supply constructed using a constant current boost switching controller according to one embodiment of the present invention. Referring to FIG. 2, a constant voltage supply 50 receives an input voltage V_{IN} (node 54) and generates an output voltage V_{OUT} (node 56) that is greater than the input voltage. In some embodiments, the input voltage is 13.6V and an output voltage V_{OUT} of about 60V is generated.

The constant voltage supply 50 includes a constant current boost switching controller 52 driving a switch M1. In the present embodiment, switch M1 is an NMOS transistor. The constant voltage supply 50 further includes an inductor L1 and a diode D1 connected in series between the input voltage V_{IN} (node 54) and the output voltage V_{OUT} (node 56). The anode of diode D1 is connected to the inductor L1 while the cathode of diode D1 is connected to the output voltage node 56. The node 58 between the inductor L1 and the diode D1 is connected to the drain of the switch M1 and is the switching voltage V_{SW}. An output capacitor C_{OUT} is connected between the output voltage V_{OUT} (node 56) and ground. Output capacitor C_{OUT} can be formed as a single capacitor or a combination of two or more capacitors, such as capacitors connected in parallel. The output capacitor C_{OUT} represents the total output capacitance being coupled to the output voltage node.

To generate a constant voltage at the output voltage node 56, a resistor divider or a resistive voltage divider is connected between the output voltage node 56 and ground. The resistor divider includes a resistor R_{OUT1} and a resistor R_{OUT2} connected in series between the output voltage node 56 and ground. The feedback voltage V_{FB} is generated at the common node 62 between the resistors. Resistors R_{OUT1} and R_{OUT2} are used to divide the output voltage down to the desired feedback voltage value necessary to achieve regulation for the desired constant output voltage. The resulting feedback voltage V_{FB} replaces what the controller 52 previously saw as an indication of current through the LED string. In one embodiment, when the input voltage is 13.6V and the output voltage is 60V, resistor R_{OUT1} is 33 KΩ and resistor R_{OUT2} is 140Ω.

The constant current boost switching controller 52 receives feedback signals to control the switching of the switch M1 to regulate the output voltage V_{OUT} to a constant level. A current sense resistor R_{CS} connected between the source (node 64) of switch M1 and ground is used to sense the current I_{CS} flowing through the switch. The resistor R_{OUT2} provides the feedback voltage V_{FB} indicative of the divided-down voltage of the resistor divider of resistors R_{OUT1} and R_{OUT2}. The switch current I_{CS} and the feedback voltage V_{FB} are coupled to a control circuit 68 in the controller to generate the drive signal DRV (node 66) for driving the switch M1. As thus configured, the constant voltage supply 50 receives an input voltage V_{IN} and generates a constant output voltage V_{OUT} for driving a load with fast transient response while needing only minimal output capacitance or needing only a small value output capacitor C_{OUT}.

The operation of the constant voltage supply 50 using the constant current boost switching controller 52 is as follows. At the beginning of a duty cycle, switch M1 is closed and current flows through the inductor L1 from the input voltage V_{IN}, through switch M1 to ground. The inductor L1 stores the energy and the inductor current increases. Then, when switch M1 is open, the inductor L1 reverses polarity and the inductor current flows through diode D1 to charge the output capacitor C_{OUT} and also supply current to the load 60. In other words, when switch M1 is open, energy stored in the inductor L1 is transferred to the output capacitor C_{OUT}. As long as the switching duty cycle is fast enough, the output voltage V_{OUT} can be charged to a voltage value greater than the input voltage V_{IN}. When switch M1 is closed again, the output capacitor C_{OUT} uses the accumulated charge to supply current to the load while diode D1 prevents the capacitor C_{OUT} form discharging through switch M1.

In operation, the constant current boost switching controller drives switch M1 in an attempt to generate a constant current at the output voltage node 56. The constant voltage supply 50 uses the resistor divider of resistors R_{OUT1} and R_{OUT2} to develop a constant output voltage under the constant current control. The constant output voltage is then used to drive the load 60. As thus configured, the load 60 experience a constant voltage value at the output voltage node 56 even while the constant current boost switching controller 52 attempts to implement constant current feedback control.

The value of the output capacitor C_{OUT} is selected to obtain the desired load transient response. In the constant voltage supply 50 of FIG. 2, the output capacitor C_{OUT} can have a small capacitance value. Therefore, the constant voltage supply can generate an output voltage with fast transient response. This represents a marked improvement over conventional solutions using large value capacitors to hold the output voltage steady when a load transient is presented. Such conventional solutions are expensive and require a larger circuit footprint. In embodiments of the present invention, the output capacitor C_{OUT} can have a capacitance value as low as 4.4 μF (2×2.2 μF). Furthermore, in embodiments of the present invention, when a small value output capacitor can be used, the output capacitor can be implemented using a ceramic capacitor which has lower ESR (equivalent series resistance) than traditional methods of using >1000 μF electrolyte capacitors. By using ceramic low ESR capacitors, the output current necessary when “pinging” the transducer can be delivered faster than with traditional Electrolytic Capacitors. The additional benefit of improved reliability by using a ceramic versus electrolyte capacitor is also realized.

In the present illustration in FIG. 2, the load 60 is coupled to ground through a switch 51. When the switch 51 is turned on and off, the constant output voltage V_{OUT} is applied to the load in pulses of current at the constant output voltage level. In embodiment of the present invention, the constant voltage supply 50 is capable of delivering pulses of current to a load, such as a 100Ω load resistor, for a given pulse duration (such as >25 ms), without appreciable drop in the output voltage level. The constant voltage supply 50 of the present invention is also capable of generating a constant output voltage with high efficiency. The efficiency does not decrease even when output capacitance increases.

In one embodiment, the constant current boost switching controller 52 is implemented using the MIC3230 or MIC3231 constant current boost controller, available from Micrel Inc. of San Jose, Calif..

In cases when reducing the effect of load transient is desired, an LC tank filter may be used at the output voltage node. Furthermore, ringing on the switching voltage V_{SW} may be controlled using snubbers.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A constant voltage supply, comprising:
an inductor having a first terminal coupled to an input voltage and a second terminal;
a diode having an anode terminal coupled to the second terminal of the inductor and a cathode terminal coupled to an output voltage node;
a constant current boost switching controller configured to control a first switch, the first switch having a first current handling terminal coupled to the second terminal of the inductor and a second current handling terminal coupled to a first resistor, the first resistor being coupled between the second current handling terminal of the first switch and a ground potential to sense a current flowing through the first switch, the sensed current being provided to the constant current boost switching controller as a feedback current signal;
a capacitor coupled between the output voltage node and the ground potential; and
a resistor divider comprising a second resistor and a third resistor connected in series between the output voltage node and the ground potential, a feedback voltage signal being generated at a node between the second and third resistors and the feedback voltage signal being provided to the constant current boost switching controller,
wherein the constant current boost switching controller controls the first switch to turn on and off at a given duty cycle based on the feedback current signal and the feedback voltage signal so as to generate an output voltage having a substantially constant voltage magnitude at the output voltage node, the output voltage having a voltage value greater than the input voltage.

2. The constant voltage supply of claim 1, wherein the capacitor comprises two or more capacitors connected in parallel between the output voltage node and the ground potential.

3. The constant voltage supply of claim 1, wherein the capacitor has a small capacitance value in the range of several micro-farads.

4. The constant voltage supply of claim 1, wherein the capacitor comprises a capacitor with low equivalent series resistance.

5. The constant voltage supply of claim 4, wherein the capacitor comprises a ceramic capacitor.

6. The constant voltage supply of claim 1, wherein the first switch comprises an NMOS transistor, the first current handling terminal being a drain terminal and the second current handling terminal being a source terminal.

7. The constant voltage supply of claim 1, wherein the output voltage node is coupled to supply a load through a second switch, the second switch being turned on and off to apply the output voltage to the load in pluses of current at the constant voltage magnitude.

8. The constant voltage supply of claim 1, wherein the constant current boost switching controller is configured to regulate a current flowing through the resistor divider to a constant level, thereby generating the output voltage having substantially constant magnitude at the output voltage node.
